(19) United States
(12) Patent Application Publication
(10) Pub. No.: US 2016/0294425 A1
(43) Pub. Date: Oct. 6, 2016

(54) SELF-INTERFERENCE CANCELLATION USING DIGITAL FILTER AND AUXILIARY RECEIVER

(71) Applicant: QUALCOMM Incorporated, San Diego, CA (US)

(72) Inventors: Insoo Hwang, San Diego, CA (US); Bongyong Song, San Diego, CA (US); Joonhoi Hur, San Diego, CA (US)

(21) Appl. No.: 14/679,937

(22) Filed: Apr. 6, 2015

(51) Int. Cl. H04B 1/12; H04B 17/29; H04B 1/40; H04B 1/10

(52) U.S. Cl. CPC H04B 1/123; H04B 1/1027; H04B 17/29; H04B 1/40

(57) ABSTRACT

Aspects of the disclosure are directed to interference cancellation. A method of performing interference cancellation in a wireless device having a transmitter and a receiver includes enabling a radio frequency (RF) receive filter for a victim band from a plurality of RF receive filters in a receive path; measuring an RF filter characteristic of the enabled RF receive filter with an auxiliary receiver; configuring a programmable digital filter to match a filter characteristic to the measured RF filter characteristic to yield a reference signal; and providing the reference signal to the receive path for interference cancellation; and, the reference signal is subtracted from a receive signal in the receive path.

### TECHNICAL FIELD

This disclosure relates generally to the field of interference cancellation systems and methods, and, in particular, to the usage of an auxiliary receiver and programmable digital filter in an interference cancellation path.

### BACKGROUND

Advanced wireless devices may have multiple radios that operate on the same, adjacent, or harmonic frequencies. The radios may provide access to networks such as wireless wide area network (WWAN), a wireless local area network (WLAN), a wireless personal area network (WPAN), Global Positioning System (GPS), Global Navigation Satellite System (GLONASS), etc. Some combinations of radios can cause co-existence issues due to interference between the respective frequencies. In particular, when one radio is actively transmitting at or close to the same frequency and at a same time that another radio is receiving, the transmitting radio can cause interference to (i.e., de-sense) the receiving radio. For example, same-band interference may occur between Bluetooth (WPAN) and 2.4 GHz WiFi (WLAN); adjacent band interference between WLAN and Long Term Evolution (LTE) band 7, 40, 41; harmonic interference may occur between 5.7 GHz ISM and 1.9 GHz Personal Communications Service (PCS); and an intermodulation issue may occur between 7xx MHz and a GPS receiver.

Analog interference cancellation (AIC) cancels interference between a transmitter radio and a receiver radio by matching gain and phase of a wireless coupling path signal from the transmit antenna to the receive antenna by in a wired AIC path between the aggressor radio and the victim radio, as shown in FIG. 1. In FIG. 1, dₜ is a transmitted signal from a transmitter (aggressor) radio 102, and h_{c} is a coupling channel (wireless coupling path signal) from the transmitter radio 102 to a receiver (victim) radio 104. AIC 106 attempts to cancel the impact of the coupling channel h_{c} as reflected via the negative sign on the output of AIC 106. The cancellation may be applicable not only for the separate transmitter-receiver scenarios, but also for the scenarios where the transmitter(s) and receiver(s) share the same antenna(s). In the latter case, the over-the-air coupling channel may be further simplified to a wired channel.

Analog interference cancellation may be performed utilizing adaptive filter coefficients computed either at RF or at baseband, where baseband means utilizing a digital implementation, for example, a field programmable gate array (FPGA) or digital signal processing (DSP) elements. Baseband coefficient computation may allow more precise coefficient determination, which may lead to optimal interference cancellation. The coefficients thus computed are sent to the analog interference cancellation (AIC) circuit for conditioning the reference signal to cancel the undesired interference.

Self-interference cancellation may use an RF receive filter (a.k.a., Rx filter) in the interference cancellation path (from transmitter to receiver input) to match the frequency response in the primary receive path. With analog cancellation, an additional band pass filter may be needed per victim band; that is, a different RF receive filter may be needed for each victim band. In digital cancellation, there may be various distortions in the transmit chain (e.g., local oscillator (LO) phase noise).

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

According to various aspects of the disclosure a method for self-interference cancellation including enabling a radio frequency (RF) receive filter for a victim band from a plurality of RF receive filters in a receive path; measuring an RF filter characteristic of the enabled RF receive filter with an auxiliary receiver; configuring a programmable digital filter to match a filter characteristic to the measured RF filter characteristic to yield a reference signal; and providing the reference signal to the receive path for interference cancellation.

In various aspects, an apparatus for self-interference cancellation including an enabling device to enable a radio frequency (RF) receive filter for a victim band from a plurality of RF receive filters in a receive path; a filter to measure an RF filter characteristic of the enabled RF receive filter; a processor to configure a programmable digital filter to match a filter characteristic to the measured RF filter characteristic to yield a reference signal from the programmable digital filter; and a summer coupled to the programmable digital filter to provide the reference signal to the receive path for interference cancellation.

In various aspects, an apparatus for interference cancellation, including: at least one processor; a memory for storing a plurality of victim bands, the memory coupled to the at least one processor; means for enabling a radio frequency (RF) receive filter for one of the plurality of victim bands from a plurality of RF receive filters in a receive path; means for measuring an RF filter characteristic of the enabled RF receive filter; means for configuring a programmable digital filter to match a filter characteristic to the measured RF filter characteristic to yield a reference signal; and means for providing the reference signal through a summer to the receive path for interference cancellation.

In various aspects, a computer-readable storage medium storing computer executable code, operable on a device including at least one processor; a memory for storing a plurality of victim bands, the memory coupled to the at least one processor; and the computer executable code including: instructions for causing the at least one processor to enable a radio frequency (RF) receive filter for one of the plurality of victim bands from a plurality of RF receive filters in a receive path; instructions for causing the at least one processor to measure an RF filter characteristic of the enabled RF receive filter; instructions for causing the at least one processor to configure a programmable digital filter to match a filter characteristic to the measured RF filter characteristic to yield a reference signal; and instructions for causing the at least one processor to provide the reference signal through a summer to the receive path for interference cancellation.

These and other aspects of the present disclosure will become more fully understood upon a review of the detailed description, which follows. Other aspects, features, and embodiments of the present disclosure will become apparent to those of ordinary skill in the art, upon reviewing the following description of specific, exemplary embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the present disclosure discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a block diagram illustrating an analog interference cancellation system.

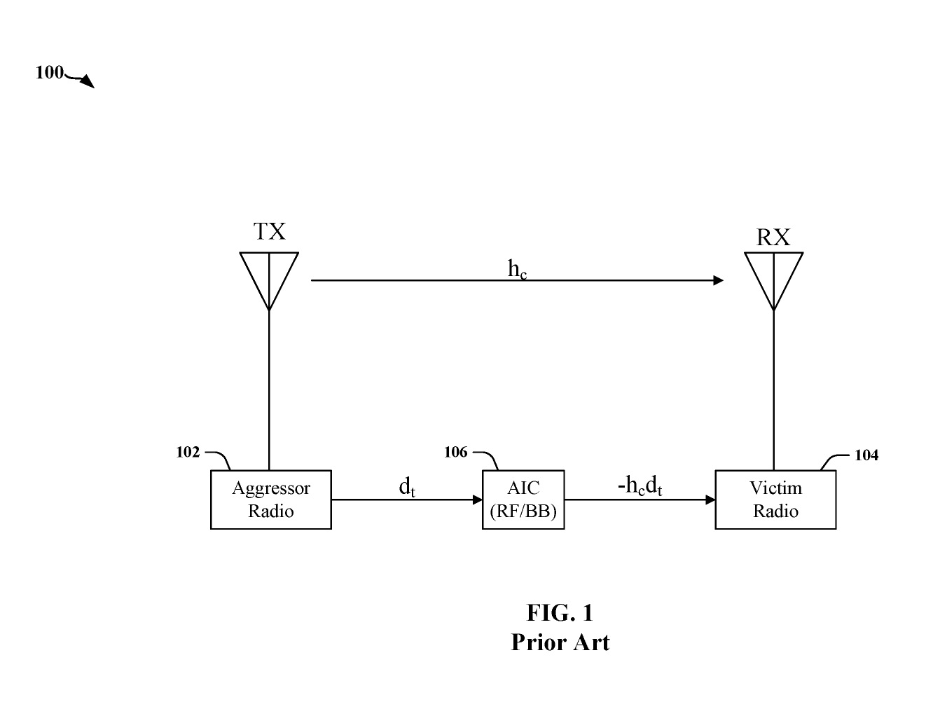

FIG. 2 is a diagram illustrating a networking environment that includes one or more wireless communication devices.

FIG. 3 is a block diagram illustrating a wireless communication device having plural transmitters and plural receivers, according to various embodiments of the disclosure.

FIG. 4 a block diagram illustrating an analog interference cancellation (IC) system which employs a plurality of Rx filters in a reference path.

FIG. 5 is a block diagram illustrating an example interference canceller system with a programmable digital filter and an auxiliary receiver.

FIG. 6 depicts the example interference canceller system illustrated in FIG. 5 with a pin-to-pin connection and a test signal path.

FIG. 7 is an example flow diagram illustrating self-interference cancellation in accordance with the present disclosure.

FIG. 8 is a diagram illustrating an example of a hardware implementation for an apparatus employing a processing employing a processing circuit adapted according to certain aspects disclosed herein.

FIG. 9 is a block diagram illustrating an example of an apparatus employing a processing circuit that may be adapted according to certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Various aspects of the disclosure relate to systems and methods for cancelling local interference resulting from transmissions by one radio (transceiver) that affect the receiving performance of a second radio (transceiver) operating on the same or adjacent, harmonic frequencies, or intermodulation product frequencies. In particular aspects, an interference cancellation system is adaptable for different radio combinations. For instance, for a co-existence issue caused by a first combination of radios, a transmitting radio (e.g., WiFi) may be selected for an input of an interference cancellation (IC) circuit and a receiving radio (e.g., Bluetooth) may be selected for the output of the interference cancellation circuit. For a co-existence issue caused by a second (different) combination of radios, the transmitting radio (e.g., WiFi) may be selected for the input of the interference cancellation circuit and the receiving radio (e.g., LTE band 7) may be selected for the output of the interference cancellation circuit. It should be noted that the terms cancellation (as in interference cancellation) and variants thereof may be synonymous with reduction, mitigation, and/or the like in that at least some interference is reduced.

Within the scope of the present disclosure, any suitable interference cancellation circuit may be utilized. In some aspects of the disclosure, an interference cancellation circuit may be an analog one-tap adaptive filter configured to match the signal in the interference cancellation path with the signal in the coupling path. In various examples, the analog one-tap adaptive filter is an analog one-tap least mean square (LMS) adaptive filter. The LMS adaptive filter may operate such that it mimics a desired filter utilizing filter coefficients calculated to produce the least mean square of an error signal, which may represent the difference between a desired signal and an observed or received signal. A conventional one-tap interference cancellation filter ideally focuses its peak cancellation energy at the frequency where the power of an interfering signal is at its highest and accordingly can typically address one type of interference and/or interference affecting one frequency or band of frequencies. A DC offset may be applied to the filter to actively steer the cancellation center, with the value of the DC offset being automatically calculated in the digital domain in accordance with a baseband signal derived from the receiver. The DC offset may be generated utilizing filter coefficients calculated in the digital domain in accordance with the baseband signal.

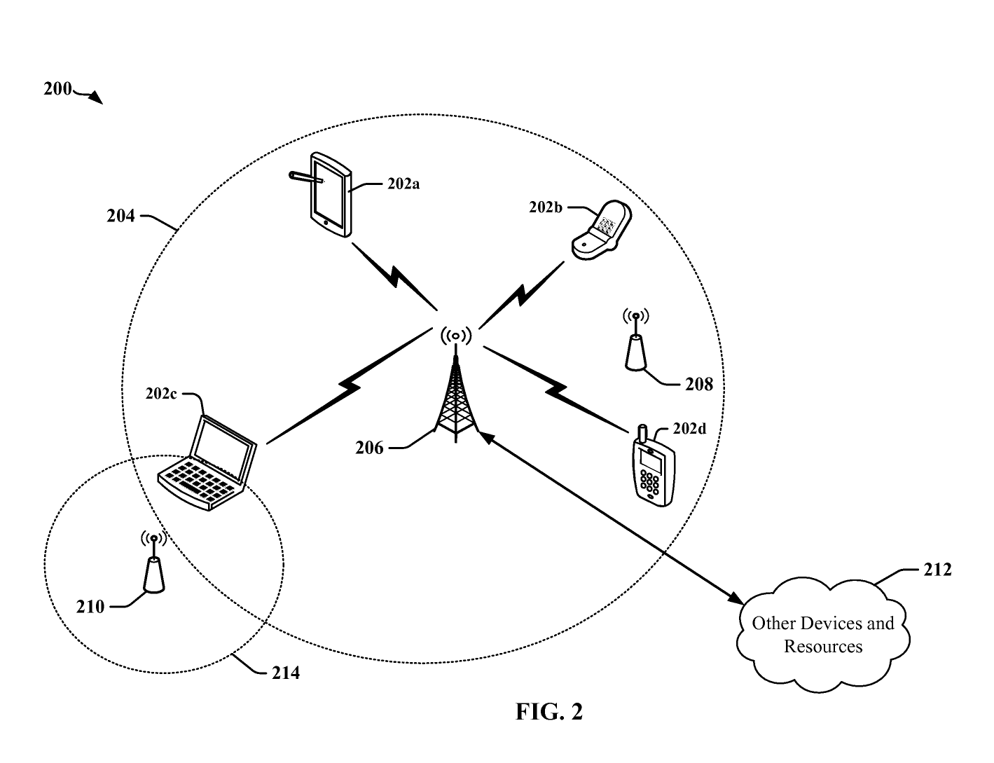

FIG. 2 is a diagram illustrating a networking environment 200 that includes one or more wireless communication devices 202a-202d. Each wireless communication device 202a-202d may be adapted or configured to transmit and/or receive wireless signals to/from at least one access point 206, 208, 210. In some instances, the wireless communication device 202a-202d may be adapted or configured to transmit and/or receive wireless signals to/from at least one other wireless communication device 202a-202d. The one or more wireless communication devices 202a-202d may include a mobile device and/or a device that, while movable, is primarily intended to remain stationary. In various examples, the device may be a cellular phone, a smart phone, a personal digital assistant, a portable computing device, a wearable computing device, and appliance, a media player, a navigation device, a tablet, etc. The one or more wireless communication devices 202a-202d may also include a stationary device (e.g., a desktop computer, machine-type communication device, etc.) enabled to transmit and/or receive wireless signals. The one or more wireless communication devices 202a-202d may include an apparatus or system embodied in or constructed from one or more integrated circuits, circuit boards, and/or the like that may be operatively enabled for use in another device. Thus, as used herein, the terms “device” and “mobile device” may be used interchangeably as each term is intended to refer to any single device or any combinable group of devices that may transmit and/or receive wireless signals.

One or more of the access points 206, 208, 210 may be associated with a radio access network (RAN) 204, 214 that provides connectivity utilizing a radio access technology (RAT). The RAN 204, 214 may connect the one or more wireless communication devices 202a-202d to a core network. In various examples, the RAN 204, 214 may include a WWAN, a WLAN, a WPAN, a wireless metropolitan area network (WMAN), a Bluetooth communication system, a WiFi communication system, a Global System for Mobile communication (GSM) system, an Evolution Data Only/Evolution Data Optimized (EVDO) communication system, an Ultra Mobile Broadband (UMB) communication system, an LTE communication system, a Mobile Satellite Service-Ancillary Terrestrial Component (MSS-ATC) communication system, and/or the like.

The RAN 204, 214 may be enabled to communicate with and/or otherwise operatively access other devices and/or resources as represented simply by cloud 212. For example, the cloud 212 may include one or more communication devices, systems, networks, or services, and/or one or more computing devices, systems, networks, or services, and/or the like or any combination thereof.

In various examples, the RAN 204, 214 may utilize any suitable multiple access and multiplexing scheme, including but not limited to, Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), etc. In examples where the RAN 204, 214 is a WWAN, the network may implement one or more standardized RATs such as Digital Advanced Mobile Phone System (D-AMPS), IS-95, cdma2000, Global System for Mobile Communications (GSM), UMTS, eUTRA (LTE), or any other suitable RAT. GSM, UMTS, and eUTRA are described in documents from a consortium named “3rd Generation Partnership Project” (3GPP). IS-95 and cdma2000 are described in documents from a consortium named “3rd Generation Partnership Project 2” (3GPP2). 3GPP and 3GPP2 documents are publicly available. In examples where the RAN 204, 214 is a WLAN, the network may be an IEEE 802.11x network, or any other suitable network type. In examples where the RAN 204, 214 is a WPAN, the network may be a Bluetooth network, an IEEE 802.15x, or any other suitable network type.

A wireless communication device 202a-202d may include at least one radio (also referred to as a transceiver). The terms “radio” or “transceiver” as used herein refer to any circuitry and/or the like that may be enabled to receive wireless signals and/or transmit wireless signals. In particular aspects, two or more radios may be enabled to share a portion of circuitry and/or the like (e.g., a processing unit, memory, etc.). That is, the terms “radio” or “transceiver” may be interpreted to include devices that have the capability to both transmit and receive signals, including devices having separate transmitters and receivers, devices having combined circuitry for transmitting and receiving signals, and/or the like.

In some aspects, a wireless communication device 202a-202d may include a first radio enabled to receive and/or transmit wireless signals associated with at least a first network of a RAN 204, 214 and a second radio that is enabled to receive and/or transmit wireless signals associated with an access point 206, 208, 210, a peer device or other transmitter that may geographically overlap or be collocated with the RAN 204, 214, and/or a navigation system (e.g., a satellite positioning system and/or the like).

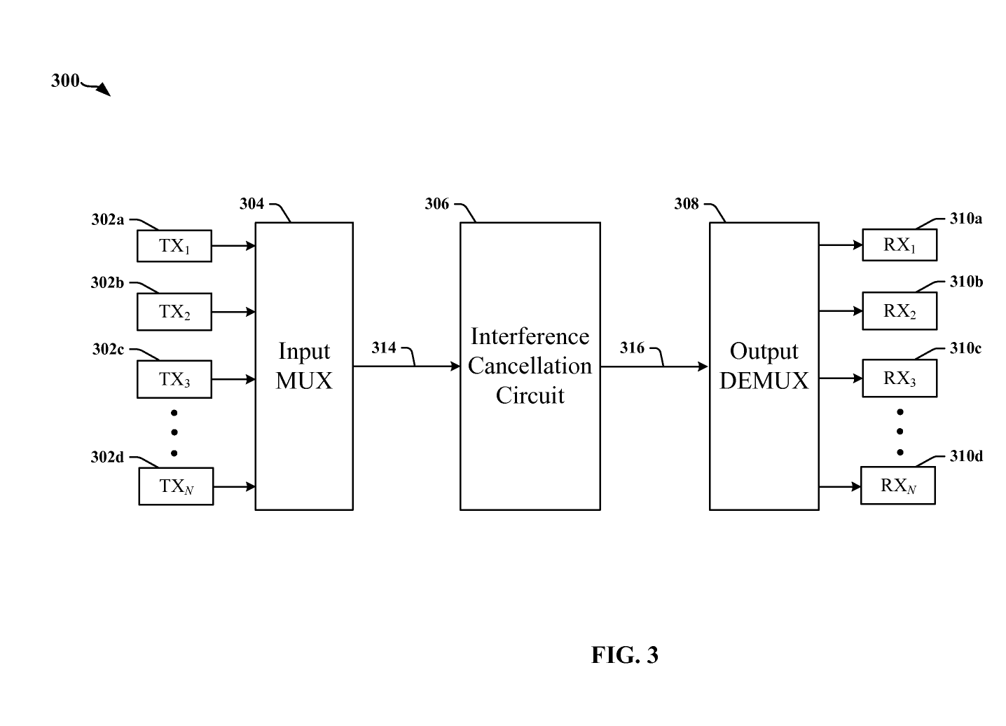

FIG. 3 is a block diagram illustrating a wireless communication device 300 that includes a plurality of transmitters 302a-302d and a plurality of receivers 310a-310d, in accordance with certain aspects disclosed herein. The transmitters 302a-302d and receivers 310a-310d may be provided as N receiver/transmitter (Rx/Tx) circuits, including a first Rx/Tx circuit 310a/302a, a second Rx/Tx circuit 310b/302b, a third Rx/Tx circuit 310c/302c, and an Nth Rx/Tx circuit 310d/302d. Coexistence issues may occur when one or more transmitters 302a-302d are actively transmitting, and one or more receivers 310a-310d are actively receiving.

Each of the Rx/Tx circuits 310a/302a, 310b/302b, 310c/302c, and/or 310d/302d may be configured to operate according to certain parameters including, for example, a respective frequency, radio frequency circuits with group delays, coupling channel gains to other Tx/Rx circuits Rx/Tx circuits 310a/302a, 310b/302b, 310c/302c, 310d/302d, and/or the like. For instance, the first Tx/Rx circuit 310a/302a may operate at a first frequency f₁ with a first delay d₁, the second Tx/Rx circuit 310b/302b may operate at a second frequency f₂ with a second delay d₂, the third Tx/Rx circuit 310c/302c may operate at a third frequency f₃ with a third delay d₃, and the N-th Tx/Rx circuit 310d/302d may operate at an N-th frequency f_{N} with an N-th delay d_{N}. The first Tx/Rx circuit 310a/302a may have a coupling channel gain h₁₂ to the second Tx/Rx circuit 310b/302b, a coupling channel gain h₁₃ to the third Tx/Rx circuit 310c/302c, and a coupling channel gain h_{1N} to the N-th Tx/Rx circuit 310d/302d, respectively. Other Tx/Rx circuits 310a/302a, 310b/302b, 310c/302c, 310d/302d may have different coupling channel gains to various Tx/Rx circuit 310a/302a, 310b/302b, 310c/302c, 310d/302d.

In various aspects, the wireless communication device 300 is configured to reduce interference produced among Tx/Rx circuits 310a/302a, 310b/302b, 310c/302c, 310d/302d operating, for example, on the same, adjacent, harmonic, or sub-harmonic frequencies. A wireless communication device 300 may be configured or adapted for different Tx/Rx circuit combinations. That is, the wireless communication device 300 may be configured to cancel interference based on a co-existence issue caused by current combination of Tx/Rx circuits 310a/302a, 310b/302b, 310c/302c, and/or 310d/302d. For example, a co-existence issue at a time T₁ may be caused when the first transmitter 302a is employed for WiFi and the second receiver 310b is employed for Bluetooth. In some systems, the apparatus may be configured to selectively provide the output of the first transmitter 302a to an interference cancellation (IC) circuit 306, which may then provide an interference cancelation signal 316 to the second receiver 310b. Accordingly, the interference cancellation (IC) circuit 306, interference caused by the aggressor Tx/Rx circuit 310a/302a upon the victim Tx/Rx circuit 310b/302b can be reduced. In various examples, the coupling channel gain from the aggressor 310a/302a to the victim Tx/Rx circuit 310b/302b may be −10 dB based on separation of two antennas, and the interference cancellation (IC) circuit 306 may be configured to match this gain for successful interference cancellation. In operation aspects, the wireless communication device 300 may include a multiplexer (MUX) circuit 304 and a demultiplexer (DEMUX) circuit 308 that may be controlled to select an interference cancellation configuration.

Interference cancellation in a scenario with many victim bands may be based on either analog interference cancellation (IC) or digital interference cancellation systems. Analog IC typically requires a unique RF receive filter per victim band. Alternatively, analog IC may require a common configurable filter with multiple delay lines. In either case, the implementation complexity of analog IC may be high. Although the term “interference” is used in the present disclosure, in various examples, other terms, such as but not limited to, “self-interference,” “internal inference,” and “intra-device interference” may also be applicable.

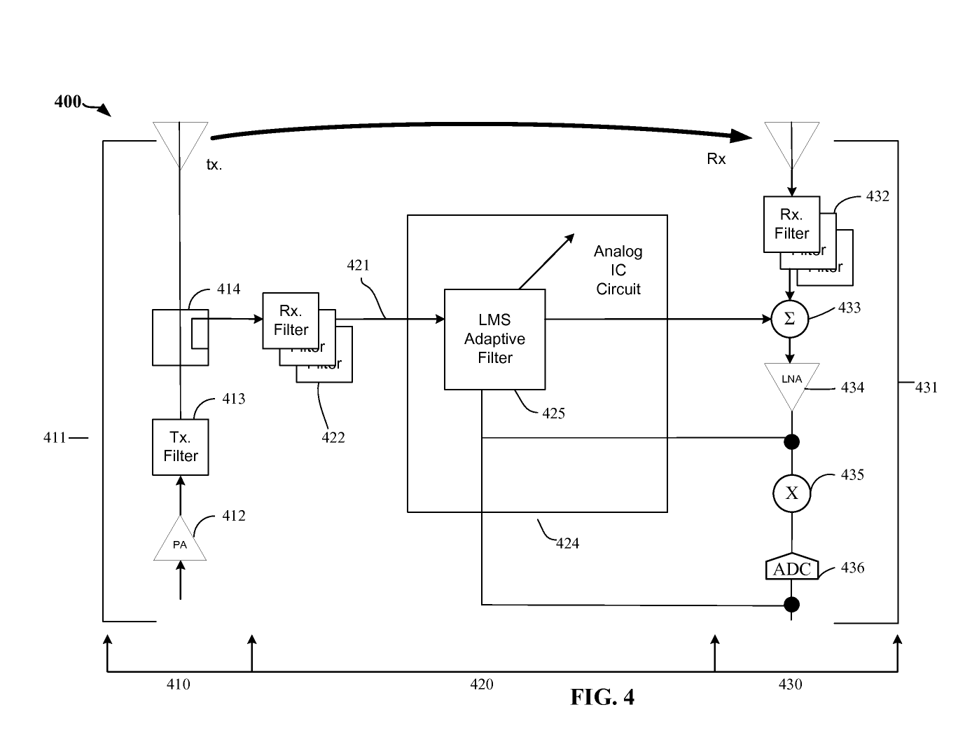

FIG. 4 is a block diagram 400 illustrating an analog interference cancellation (IC) system which employs a plurality of Rx filters (a.k.a., RF receive filters) in a reference path. In FIG. 4, the left side 410 is a transmit path 411, the right side 430 is a receive path 431, and the middle 420 is a reference path 421 with a plurality of Rx filters 422 and an analog interference cancellation (AIC) circuit 424. The transmit path 411 includes a power amplifier 412, a transmit filter 413, and a coupler 414. The receive path 431 includes a plurality of Rx filters 432, a summer 433, a low noise amplifier (LNA) 434, a mixer 435, and an analog to digital converter (ADC) 436. The reference path 421 includes a plurality of Rx filters 422 and an analog interference cancellation (AIC) circuit 424. As in various examples, the AIC circuit 424 may include an adaptive filter, such as the least mean square (LMS) adaptive filter 425 shown in FIG. 4. Other components not shown or listed herein may be included in the transmit path 411, the receive path 431 and/or the reference path 421 and be within the scope and spirit of the present disclosure. Also, each of the transmit path 411, receive path 431, and/or reference path 421 may not need to include all the components listed herein.

The reference path 421 generates an interference cancellation signal that is sent to the receive path 431. For example, the interference cancellation signal may be derived from the transmit path 411 through the coupler 414 shown in FIG. 4. The reference path 421 may use the plurality of Rx filters 422 to minimize group delay mismatch between the reference path 421 and the receive path 431. However, since the cost of each Rx filter 422 may be significant, the need to provide the plurality of Rx filters may be inefficient and costly. Moreover, some RF gain may be lost due to the filter gain variation for the Rx filters.

Conventional digital IC may focus on large signal cancellation, and may have performance limits due to various distortions in a transmit path, such as local oscillator (LO) phase noise. In certain cases, conventional digital IC may need to account for memory effects, i.e., state information of the circuit, in addition to signal distortions. In addition, conventional digital IC may not fully handle certain distortions added in the transmit path, such as phase noise.

In addition, an auxiliary receiver may be used in an interference cancellation technique to provide online internal calibration of various implementation impairments, e.g., inner loop power control (ILPC) discrepancy, local oscillator (LO) feedthrough, in-phase/quadrature (IQ) imbalance, second order intercept (IP2) calibration, etc. For example, the auxiliary receiver may be used only intermittently, i.e., only as needed. In various examples, the auxiliary receiver may be a feedback receiver, a diversity receiver or a carrier aggregation receiver. Other forms of auxiliary receiver may be used within the scope and spirit of the present disclosure.

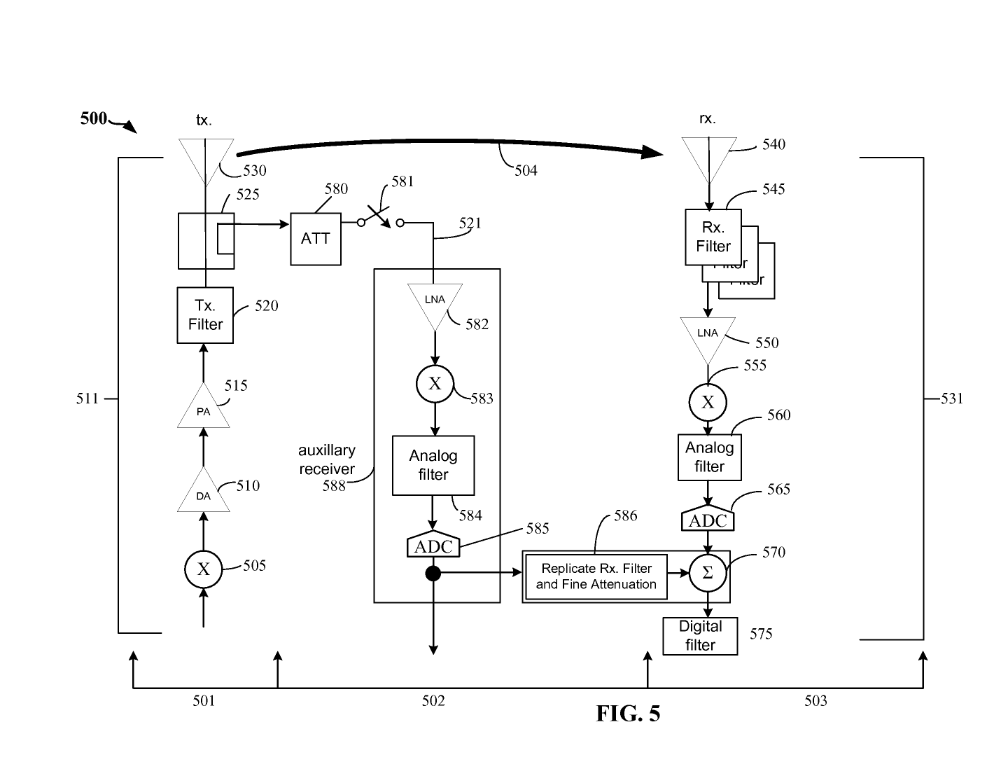

FIG. 5 is a block diagram illustrating an example interference canceller system 500 with a programmable digital filter 586 and an auxiliary receiver 588. In various examples, the interference canceller system 500 shown in FIG. 5 may include self-interference cancellation by its implementation of a programmable digital filter 586 in lieu of one or more Rx filters in the reference path 521. In various examples, passive filter modeling is achieved with the auxiliary receiver 588.

The interference canceller system 500 includes a transmit path 511 shown in the left side 501, a receive path 531 shown on the right side 503, and a reference path 521 shown in the middle 502. In some examples, the transmit path 511 may be referred to as a transmitter and the receive path 531 may be referred to as a receiver. Although not shown, the interference canceller system 500 may include more than one receive path 531 with each receive path associated with a different receive frequency band.

The transmit path 511 includes a mixer 505 (e.g., an upconversion mixer), a driver amplifier 510, a power amplifier 515, a transmit filter 520, a coupler 525, and a transmit antenna 530. The reference path 521 includes an attenuator 580 (which, for example, may be a smart attenuator and may be used for coarse attenuation), a switch 581, an auxiliary receiver 588, and a programmable digital filter 586. In various examples, the auxiliary receiver 588 includes one or more of the following components (shown in FIG. 5) as a replicated low noise amplifier 582, a replicated mixer 583, a replicated analog filter 584, and a replicated analog-to-digital converter (ADC) 585. In various examples, a smart attenuator is an attenuator with flexible, adjustable, and/or tunable attenuation capabilities. The programmable digital filter 586 may replicate the functions of one or more Rx filters and provide attenuation (e.g., fine attenuation). For example, the programmable digital filter 586 may incorporate a fine attenuator. One skilled in the art would understand that the level of attenuation between what is fine attenuation and what is coarse attenuation is relative and may be dependent on the characteristics of the reference path. That is, fine attenuation has smaller level of attenuation steps than coarse attenuation. In various examples, the programmable digital filter 586 is coupled to a receive path summer 570 in the receive path 531.

The receive path 531 includes a receive antenna 540, a plurality of Rx filters 545 (a.k.a., radio frequency (RF) receive filters), a receive path low noise amplifier (LNA) 550, a receive path mixer 555 (e.g., a downconversion mixer), a receive path analog filter 560, a receive path analog to digital converter (ADC) 565, a receive path summer 570 (the receive path summer 570 is coupled to the reference path 521), and a digital filter 575 to measure RF characteristic of the receive path 531. Other components not shown or listed herein may be included in the transmit path 511, the receive path 531 and/or the reference path 521 and be within the scope and spirit of the present disclosure. Also, each of the transmit path 511, receive path 531, and/or reference path 521 may not need to include all the components listed herein. As shown in FIG. 5, the transmission path 504 provides the undesired wireless communication between the transmit antenna 530 and the receive antenna 540.

In various examples, the auxiliary receiver 588 provides a reference path 521 which is matched (e.g., in amplitude and phase) to the receive path 531, except for the Rx filter(s) 545 in the receive path 531. In the reference path 521, after the replicated ADC 585, a programmable digital filter is employed to replicate the Rx filter(s) in the receive path 531, for example, by replicating its frequency response in both amplitude and phase. For example, the same programmable digital filter may be applicable to a different receive path. In various examples, each victim band needs a different Rx filter in the receive path. A single programmable digital filter is the substitute for the different Rx filters in terms of providing a matched frequency response in both amplitude and phase for each of the Rx filters.

In various aspects, the plurality of Rx filters 545 in the receive path 431 may be replicated with a single programmable digital filter (i.e., programmable digital filter 586) in the reference path 521. Rx filters may include analog components, such as resistors and capacitors, which may cause passband ripples. Moreover, to regenerate the plurality of Rx filters, multiple delay lines may be required which may be costly. On the other hand, usage of a single programmable digital filter may present benefits of simple adjustment for the delay and attenuation characteristics of the Rx filter(s) for accurate matching.

The programmable digital filter 586 may be synthesized many ways. For example, canonic filter characteristics, i.e., kernels, which are known a priori, may be used to construct the programmable digital filter. For example, the programmable digital filter 586 may include a plurality of multiple delays (e.g., taps) associated with gains. The programmable digital filter 586 may also be synthesized using known filter synthesis techniques such as an Impulse Invariance Transformation or Bilinear Transformation. In other examples, polynomial curve fitting or sinc (e.g., (sin x)/x) interpolation are other filter synthesis techniques that may be used. For example, given a finite number of frequency domain samples s1, s2, s3, . . . , synthesize a polynomial curve to establish a polynomial curve approximation to the filter frequency response.

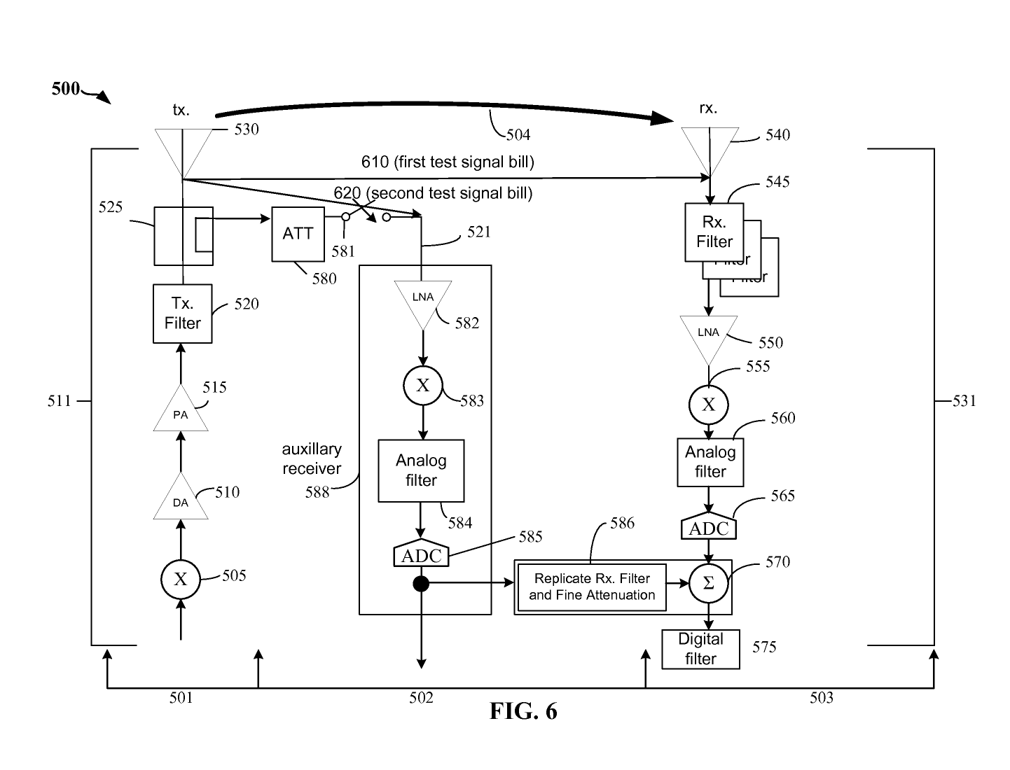

FIG. 6 depicts the example interference canceller system 500 illustrated in FIG. 5 with a pin-to-pin connection 610 and a test signal path 620. The frequency response of the Rx filter(s) 545 may be estimated using a test signal. A test signal originating from the transmit path 511 may be used to obtain an estimate of the frequency response. For example, the amplitude of the test signal is low enough to avoid significant nonlinear distortions or artifacts (e.g., harmonics, intermodulation products, spurious products, etc.) from the power amplifier 515 in the transmit path 511. By injecting the test signal, this is not subject to a memory effect and has reduced signal distortion due to the usage of a signal tone with a low amplitude.

To inject the test signal(s), a pin-to-pin connection 610 (which is a hardline connection) between the transmit antenna 530 and receive antenna 540 is provided to inject a first test signal 611 into the receive path 531. Once the first test signal 611 is injected into the receive path 531, measure the frequency response of the selected Rx filter 545 (a.k.a., measured Rx filter frequency response). In the testing, one of the Rx filters 545 is selected to be tested. The rest of the Rx filters 545 may each be individually tested in sequence. The amplitude of the test signal 611 is set to a level low enough to only result in a linear response, for example, in the time domain. That is, the amplitude of the test signal 611 is set low enough to avoid significant nonlinear distortions or artifacts (e.g., harmonics, intermodulation products, spurious products, etc.) from the power amplifier 515 in the transmit path 511.

Next, a second test signal 621 is injected into the reference path 521 from the transmit antenna 530 through the test signal path 620. Using the second test signal 621, the frequency response of the programmable digital filter 586 is measured at a default setting (a.k.a., measured digital filter frequency response). The amplitude of the test signal 621 is set to a level low enough to only result in a linear response, for example, in the time domain. That is, the amplitude of the test signal 621 is set low enough to avoid significant nonlinear distortions or artifacts (e.g., harmonics, intermodulation products, spurious products, etc.) from the power amplifier 515 in the transmit path 511. The first test signal 611 and the second test signal 621 may or may not be the same.

Next, configure the programmable digital filter 586 to match the measured digital filter frequency response to the measure Rx filter frequency response so as to yield a reference signal. This reference signal is then provided to the receive path 531 (e.g., as an input to receive path summer 570) for interference cancellation.

In another aspect, the programmable digital filter 586 incorporates a fine attenuator that complements the attenuator 580, which may be used for coarse attenuation adjustment. Gain matching (i.e., amplitude setting) between a reference path and a receive path that uses a single attenuator in the reference path is more susceptible to inaccuracy and distortion. To insure against this, the present disclosure incorporates fine attenuation capabilities (e.g., by including one or more fine attenuators) as part of the programmable digital filter 586 to implement smart (i.e., flexible, adjustable and/or tunable) attenuation capabilities. For example, usage of the “smart” attenuation capabilities facilitate precise power adjustment for gain matching in the presence of the coarse attenuation from attenuator 580 in the reference path 521.

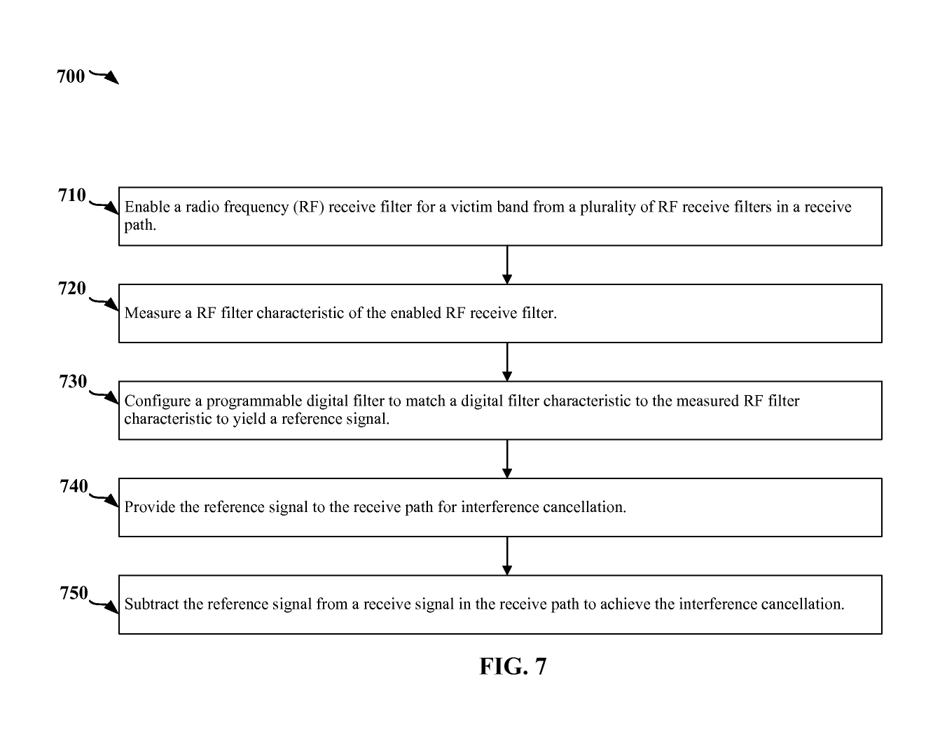

FIG. 7 is a flow diagram illustrating an example of a self-interference cancellation process 700 in accordance with the present disclosure. In block 710, enable a radio frequency (RF) receive filter (a.k.a., Rx filter) for a victim band from a plurality of RF receive filters in a receive path. In various examples, a switch, a passive microwave device, a variable coupler, a variable attenuator, or any other suitable circuit or apparatus (a.k.a., an enabling device) may be used to enable the RF receive filter. One skilled in the art would understand that various components or techniques may be used to enable the RF receive filter without deviating from the scope and spirit of the present disclosure. In various examples, the plurality of RF receive filters may be associated with different receive frequency bands. Examples of receive frequency bands may include bands for: Long Term Evolution (LTE), WiFi, Global System for Mobile Communications (GSM), Universal Mobile Telecommunications System (UMTS), WiMax, Global Positioning System (GPS), Bluetooth, Zigbee, Satellite bands such as L-band and S-band, etc. Once skilled in the art would understand that the list of receive frequency bands presented herein is not exclusive and that other receive frequency band may be used also.

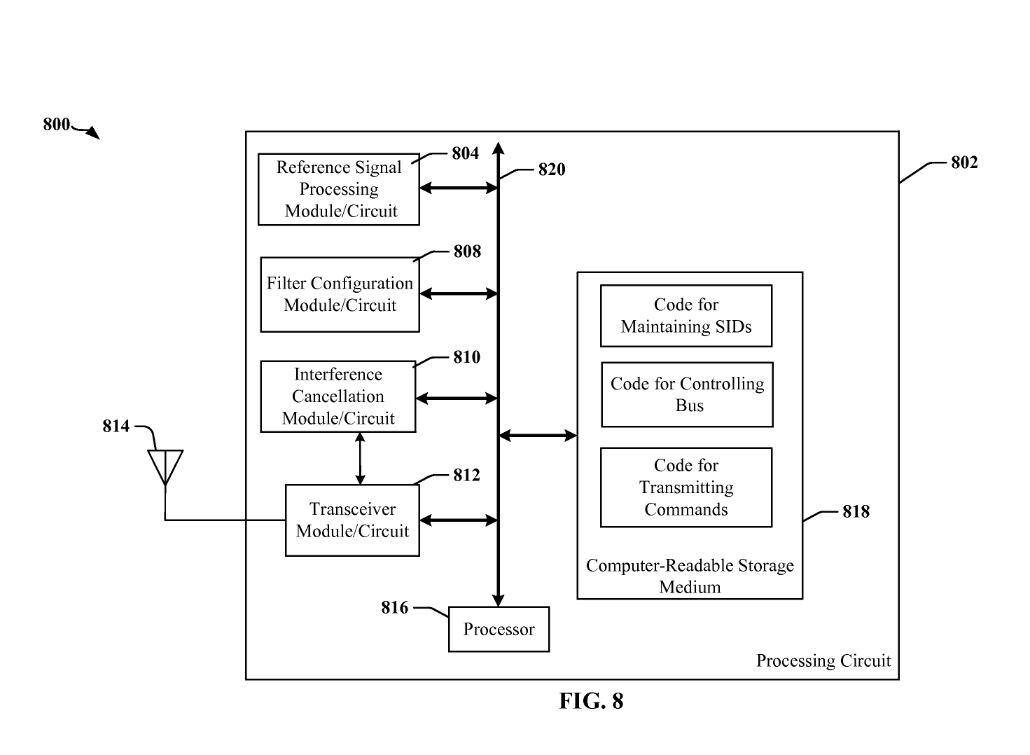

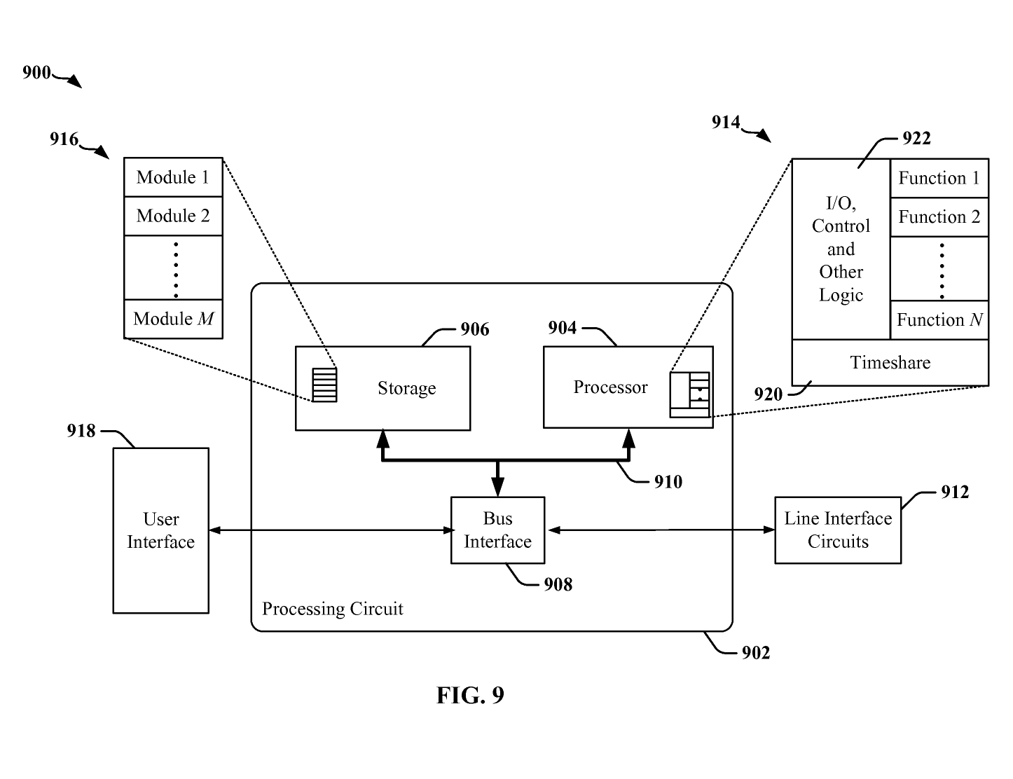

In various examples, the victim band is an RF receive band subject to interference from a transmitter that is co-located (i.e., a co-located transmitter) with a receiver that includes the plurality of RF receive filters in its receive path. The victim band may be specified by a center frequency and a bandwidth. A plurality of victim bands that matches the plurality of RF receive filters (i.e., an index associated with each victim band) may be stored in a memory (e.g., computer-readable storage medium 818 in FIG. 8 or storage 906 in FIG. 9) and may be used for a faster computation

In various examples, the enabled RF receive filter has a passband which includes that center frequency. The passband may be defined, for example, by a set of frequencies for which a filter relative amplitude (i.e., relative to maximum gain) is above a pre-defined amplitude threshold. The pre-defined amplitude threshold may be, for example, −3 dB or −10 dB. For example, the enabled RF receive filter may be a passive filter with N sections, where N is a positive integer. Or, the enabled RF receive filter may be a cavity filter, a stripline filter, a surface acoustic wave (SAW) filter, a dielectric resonator filter, etc.

In block 720, measure an RF filter characteristic of the enabled RF receive filter. In various examples, a digital filter (e.g., digital filter 575 shown in FIG. 5) may be used to measure the RF filter characteristic. In various examples, the RF filter characteristic is measured using an auxiliary receiver. Examples of an auxiliary receiver may include a feedback receiver, a diversity receiver, a carrier aggregation receiver, etc. One skilled in the art would understand that other types of auxiliary receivers may be used without departing from the scope and spirit of the present disclosure. In various examples, the RF filter characteristic includes an RF amplitude versus frequency function and an RF phase versus frequency function.

In block 730, configure a programmable digital filter to match a filter characteristic (e.g., a digital filter characteristic) to the measured RF filter characteristic to yield a reference signal. In various aspects, a controller or processor (e.g., see FIGS. 8 and 9) is used to configure the programmable digital filter. The controller or processor may be a component within the programmable digital filter. In other examples, the controller or processor may be a component adjunct to or remote from the programmable digital filter. In various examples the filter characteristic (e.g., digital filter characteristic) includes a digital amplitude versus frequency function and a digital phase versus frequency function. In various examples, the programmable digital filter is configured to match the filter characteristic to the measured RF filter characteristic by setting the digital amplitude versus frequency function to the RF amplitude versus frequency function to within an amplitude tolerance; and setting the digital phase versus frequency function to the RF phase versus frequency function to within a phase tolerance. In various examples, the controller or processor (e.g., see FIGS. 8 and 9) used to configure the programmable digital filter is further configured to do the setting. The amplitude tolerance may be, for example, +/−0.1. The phase tolerance may be, for example, +/−0.05 rad (2.86 deg). With the amplitude tolerance of +/−0.1 and phase tolerance of +/−0.05 rad (2.86 deg), the interference cancellation may be approximately 20 dB. In various aspects, a controller or processor (not shown) is used for setting the digital amplitude versus frequency function to the RF amplitude versus frequency function and for setting the digital phase versus frequency function to the RF phase versus frequency function. The controller or processor may be a component within the programmable digital filter. In other examples, the controller or processor may be a component adjunct to or remote from the programmable digital filter.

When the filter characteristic is matched to the measured RF filter characteristic, the resulting reference signal is used for interference cancelation. In various examples, the programmable digital filter includes one or more fine attenuators (e.g., one or more smart attenuators) for performing fine attenuation to complement the coarse attenuation, e.g., provided by a coarse attenuator in the reference path. The programmable digital filter is part of the reference path. One skilled in the art would understand that the level of attenuation between what is fine attenuation and what is coarse attenuation is relative and may be dependent on the characteristics of the reference path. That is, fine attenuation has smaller level of attenuation steps than coarse attenuation.

In various examples, a first test signal is injected into an input of the enabled RF receive filter to measure the RF filter characteristic. In various examples, the first test signal is injected into (or supplied to) an input of the enabled RF receive filter by a transmitter (a.k.a., transmit path 511). By injecting a known test signal into the enabled RF receive filter, the RF filter characteristic can be measured.

A second test signal is injected into a reference path to obtain the filter characteristic (e.g., digital filter characteristic). The programmable digital filter is part of the reference path. In various examples, the second test signal is injected into (or supplied to) the reference path by a transmitter (a.k.a., transmit path 511). The first test signal and the second test signal may be the same signal. By injecting a known test signal into the programmable digital filter (i.e., a reference path which includes the programmable digital filter), the filter characteristic (e.g., digital filter characteristic) can be measured. In various examples, the controller or processor (e.g., see FIGS. 8 and 9) used to configure the programmable digital filter is further configured to do the injecting of the test signals.

In various examples, a plurality of delays (not shown) and a plurality of gains (not shown) are used for configuring the programmable digital filter. The plurality of delays and the plurality of gains, for example, may implement matching the filter characteristic (e.g., to the measured RF filter characteristic). Also, in various examples, the programmable digital filter is configured to match the filter characteristic (e.g., digital filter characteristic) to the measured RF filter characteristic by performing one of the following: an Impulse Invariance Transformation, a Bilinear Transformation, a polynomial curve fitting or a sine interpolation. Since techniques related to the Impulse Invariance Transformation, the Bilinear Transformation, the polynomial curve fitting or the sine interpolation are known, they will not be described in further detail herein.

In block 740, provide the reference signal to the receive path for interference cancellation. In various aspects, a controller or processor (e.g., see FIGS. 8 and 9) is used to provide the reference signal through a summer to the receive path. The controller or processor may be a component within the programmable digital filter. In other examples, the controller or processor may be a component adjunct to or remote from the programmable digital filter. A switch (e.g., switch 581 shown in FIG. 5) or a component with a switching capability (a.k.a. a switching component) may be used to enable providing the reference signal through the summer.

And, in block 750, subtract the reference signal from a receive signal in the receive path to achieve the interference cancellation. In various examples, the summer subtracts the reference signal from the receive signal.

FIG. 8 is a diagram illustrating a simplified example of a hardware implementation for an apparatus 800 employing a processing circuit 802. The processing circuit typically has a processor 816 that may include one or more of a microprocessor, microcontroller, digital signal processor, a sequencer and a state machine. The processing circuit 802 may be implemented with a bus architecture, represented generally by the bus 820. The bus 820 may include any number of interconnecting buses and bridges depending on the specific application of the processing circuit 802 and the overall design constraints. The bus 820 links together various circuits including one or more processors and/or hardware modules, represented by the processor 816, the modules or circuits 804 and 808, transceiver circuits 812 configurable to communicate over the one or more antennas 814 and the computer-readable storage medium 818. The bus 820 may also link various other circuits such as timing sources, peripherals, voltage regulators, and power management circuits, which are well known in the art, and therefore, will not be described any further.

The processor 816 is responsible for general processing, including the execution of software stored on the computer-readable storage medium 818. In various examples, the computer-readable storage medium stores computer executable code operable on a device, for example, code for maintaining security identifiers (SIDs), code for controlling the bus and code for transmitting commands, etc. The software, when executed by the processor 816, causes the processing circuit 802 to perform the various functions described supra for any particular apparatus. The computer-readable storage medium 818 may also be used for storing data that is manipulated by the processor 816 when executing software, including data transmitted or received in RF signals transmitted over the one or more antennas 814, which may be configured as data lanes and clock lanes. The processing circuit 802 further includes at least one of the modules 804 and 808. The modules 804 and 808 may be software modules running in the processor 816, resident/stored in the computer-readable storage medium 818, one or more hardware modules coupled to the processor 816, or some combination thereof. The modules 804 and/or 808 may include microcontroller instructions, state machine configuration parameters, or some combination thereof.

In one configuration, the apparatus 800 for wireless communication includes a module and/or circuit 804 that is configured to receive and process a reference signal representative of an interfering signal transmitted by apparatus 800, a module and/or circuit 808 configured to configure a filter utilizing RF, baseband or digital feedback, and a module and/or circuit 810 configured to cancel interference in the RF signal. Although it is shown in FIG. 8 that the modules/circuits (e.g., 804, 808, 810, 812, 818) are external to processor 816, one would understand that one or more of these modules/circuits may reside within the processor 816.

FIG. 9 is a conceptual diagram 900 illustrating a simplified example of a hardware implementation for an apparatus employing a processing circuit 902 that may be configured to perform one or more functions disclosed herein. In accordance with various aspects of the disclosure, an element, or any portion of an element, or any combination of elements as disclosed herein may be implemented utilizing the processing circuit 902. The processing circuit 902 may include one or more processors 904 that are controlled by some combination of hardware and software modules. Examples of processors 904 include microprocessors, microcontrollers, digital signal processors (DSPs), field programmable gate arrays (FPGAs), programmable logic devices (PLDs), state machines, sequencers, gated logic, discrete hardware circuits, and other suitable hardware configured to perform the various functionality described throughout this disclosure. The one or more processors 904 may include specialized processors that perform specific functions, and that may be configured, augmented or controlled by one of the software modules 916. The one or more processors 904 may be configured through a combination of software modules 916 loaded during initialization, and further configured by loading or unloading one or more software modules 916 during operation.

In the illustrated example, the processing circuit 902 may be implemented with a bus architecture, represented generally by the bus 910. The bus 910 may include any number of interconnecting buses and bridges depending on the specific application of the processing circuit 902 and the overall design constraints. The bus 910 links together various circuits including the one or more processors 904, and storage 906. Storage 906 may include memory devices and mass storage devices, and may be referred to herein as computer-readable storage media and/or processor-readable storage media. The bus 910 may also link various other circuits such as timing sources, timers, peripherals, voltage regulators, and power management circuits. A bus interface 908 may provide an interface between the bus 910 and one or more transceivers 912. A transceiver 912 may be provided for each networking technology supported by the processing circuit. In some instances, multiple networking technologies may share some or all of the circuitry or processing modules found in a transceiver 912. Each transceiver 912 provides a means for communicating with various other apparatus over a transmission medium. Depending upon the nature of the apparatus, a user interface 918 (e.g., keypad, display, speaker, microphone, joystick) may also be provided, and may be communicatively coupled to the bus 910 directly or through the bus interface 908.

A processor 904 may be responsible for managing the bus 910 and for general processing that may include the execution of software stored in a computer-readable storage medium that may include the storage 906. In this respect, the processing circuit 902, including the processor 904, may be used to implement any of the methods, functions and techniques disclosed herein. The storage 906 may be used for storing data that is manipulated by the processor 904 when executing software, and the software may be configured to implement any one of the methods disclosed herein.

One or more processors 904 in the processing circuit 902 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 906 or in an external computer-readable storage medium. The external computer-readable storage medium and/or storage 906 may include a non-transitory computer-readable storage medium. A non-transitory computer-readable storage medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable storage medium and/or storage 906 may also include, by way of example, a carrier wave, a transmission line, and any other suitable medium for transmitting software and/or instructions that may be accessed and read by a computer. Computer-readable storage medium and/or the storage 906 may reside in the processing circuit 902, in the processor 904, external to the processing circuit 902, or be distributed across multiple entities including the processing circuit 902. The computer-readable storage medium and/or storage 906 may be embodied in a computer program product. By way of example, a computer program product may include a computer-readable storage medium in packaging materials. Those skilled in the art will recognize how best to implement the described functionality presented throughout this disclosure depending on the particular application and the overall design constraints imposed on the overall system.

The storage 906 may maintain software maintained and/or organized in loadable code segments, modules, applications, programs, etc., which may be referred to herein as software modules 916. Each of the software modules 916 may include instructions and data that, when installed or loaded on the processing circuit 902 and executed by the one or more processors 904, contribute to a run-time image 914 that controls the operation of the one or more processors 904. When executed, certain instructions may cause the processing circuit 902 to perform functions in accordance with certain methods, algorithms and processes described herein.

Some of the software modules 916 may be loaded during initialization of the processing circuit 902, and these software modules 916 may configure the processing circuit 902 to enable performance of the various functions disclosed herein. For example, some software modules 916 may configure internal devices and/or logic circuits 922 of the processor 904, and may manage access to external devices such as the transceiver 912, the bus interface 908, the user interface 918, timers, mathematical coprocessors, and so on. The software modules 916 may include a control program and/or an operating system that interacts with interrupt handlers and device drivers, and that controls access to various resources provided by the processing circuit 902. The resources may include memory, processing time, access to the transceiver 912, the user interface 918, and so on.

One or more processors 904 of the processing circuit 902 may be multifunctional, whereby some of the software modules 916 are loaded and configured to perform different functions or different instances of the same function. The one or more processors 904 may additionally be adapted to manage background tasks initiated in response to inputs from the user interface 918, the transceiver 912, and device drivers, for example. To support the performance of multiple functions, the one or more processors 904 may be configured to provide a multitasking environment, whereby each of a plurality of functions is implemented as a set of tasks serviced by the one or more processors 904 as needed or desired. In various examples, the multitasking environment may be implemented utilizing a timesharing program 920 that passes control of a processor 904 between different tasks, whereby each task returns control of the one or more processors 904 to the timesharing program 920 upon completion of any outstanding operations and/or in response to an input such as an interrupt. When a task has control of the one or more processors 904, the processing circuit is effectively specialized for the purposes addressed by the function associated with the controlling task. The timesharing program 920 may include an operating system, a main loop that transfers control on a round-robin basis, a function that allocates control of the one or more processors 904 in accordance with a prioritization of the functions, and/or an interrupt driven main loop that responds to external events by providing control of the one or more processors 904 to a handling function.

In various examples, the method of flow diagram 700 may be implemented by one or more of the exemplary interference cancellation systems illustrated in FIGS. 5 and/or 6. In other examples, the method of flow diagram 700 may be implemented by the exemplary wireless communication device illustrated in FIG. 3. In yet other examples, the method of flow diagram 700 may be implemented by the processing circuit illustrated in FIG. 8 and/or FIG. 9. In various examples, the method of flow diagram 700 may be implemented by any other suitable apparatus or means for carrying out the described functions.

Several aspects of a telecommunications system have been presented. As those skilled in the art will readily appreciate, various aspects described throughout this disclosure may be extended to various types of telecommunication systems, network architectures and communication standards.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first die may be coupled to a second die in a package even though the first die is not directly physically in contact with the second die. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, blocks, features and/or functions illustrated in the figures may be rearranged and/or combined into a single component, block, feature or function or embodied in several components, blocks, or functions. Additional elements, components, blocks, and/or functions may also be added without departing from novel features disclosed herein. The apparatus, devices, and/or components illustrated in the various drawings may be configured to perform one or more of the methods, features, or blocks described herein. The novel algorithms described herein may also be efficiently implemented in software and/or embedded in hardware.

It is to be understood that the specific order or hierarchy of blocks in the methods disclosed is an illustration of exemplary processes. Based upon design preferences, it is understood that the specific order or hierarchy of blocks in the methods may be rearranged. The accompanying method claims present elements of the various blocks in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited utilizing the phrase “means for” or, in the case of a method claim, the element is recited utilizing the phrase “step for.”

1. A method for self-interference cancellation comprising:
enabling a radio frequency (RF) receive filter for a victim band from a plurality of RF receive filters in a receive path, wherein each of the plurality of RF receive filters is for a unique band, and wherein said enabling is done prior to downconverting an RF signal in the receive path;
measuring an RF filter characteristic of the enabled RF receive filter with an auxiliary receiver;
configuring a programmable digital filter to match a filter characteristic to the measured RF filter characteristic to yield a reference signal; and
providing the reference signal to the receive path for interference cancellation.

2. The method of claim 1, wherein the victim band is an RF receive band subject to interference from a co-located transmitter.

3. The method of claim 2, wherein the victim band is specified by a center frequency and a bandwidth, and the enabled RF receive filter has a passband that includes the center frequency.

4. The method of claim 1, wherein the auxiliary receiver is a feedback receiver or a diversity receiver.

5. The method of claim 1, wherein the RF filter characteristic comprises an RF amplitude versus frequency function and an RF phase versus frequency function.

6. The method of claim 5, wherein the filter characteristic comprises a digital amplitude versus frequency function and a digital phase versus frequency function.

7. The method of claim 6, wherein the configuring the programmable digital filter to match the filter characteristic to the measured RF filter characteristic comprises:
setting the digital amplitude versus frequency function to the RF amplitude versus frequency function to within an amplitude tolerance; and
setting the digital phase versus frequency function to the RF phase versus frequency function to within a phase tolerance.

8. The method of claim 1, further comprising injecting a first test signal into an input of the enabled RF receive filter for measuring the RF filter characteristic.

9. The method of claim 8, further comprising injecting a second test signal into a reference path to obtain the filter characteristic, wherein the programmable digital filter is part of the reference path.

10. The method of claim 9, wherein the first test signal and the second test signal are the same test signal.

11. The method of claim 1, further comprising performing fine attenuation within the programmable digital filter to complement a coarse attenuation in a reference path, wherein the programmable digital filter is part of the reference path.

12. The method of claim 1, further comprising implementing a plurality of delays and a plurality of gains for configuring the programmable digital filter.

13. The method of claim 1, wherein the configuring the programmable digital filter to match the filter characteristic to the measured RF filter characteristic includes performing one of the following: an Impulse Invariance Transformation, a Bilinear Transformation, a polynomial curve fitting or a sinc interpolation.

14. The method of claim 1, further comprising subtracting the reference signal from a receive signal in the receive path.

15. The method of claim 14, further comprising enabling a switching component to allow providing the reference signal to the receive path.

16. An apparatus for self-interference cancellation comprising:
an enabling device to enable a radio frequency (RF) receive filter for a victim band from a plurality of RF receive filters in a receive path, wherein each of the plurality of RF receive filters is for a unique band;
a mixer to downconvert an RF signal in the receive path, wherein said enabling device operates prior to downconverting said RF signal in the receive path;
a filter to measure an RF filter characteristic of the enabled RF receive filter;
a processor to configure a programmable digital filter to match a filter characteristic to the measured RF filter characteristic to yield a reference signal from the programmable digital filter; and
a summer coupled to the programmable digital filter to provide the reference signal to the receive path for interference cancellation.

17. The apparatus of claim 16, wherein the enabling device is one of the following: a switch, a passive microwave device, a variable coupler or a variable attenuator.

18. The apparatus of claim 16, wherein the victim band is an RF receive band subject to interference from a co-located transmitter.

19. The apparatus of claim 18, wherein the victim band is specified by a center frequency and a bandwidth, and the enabled RF receive filter has a passband that includes the center frequency.

20. The apparatus of claim 16, wherein the RF filter characteristic comprises an RF amplitude versus frequency function and an RF phase versus frequency function.

21. The apparatus of claim 20, wherein the filter characteristic comprises a digital amplitude versus frequency function and a digital phase versus frequency function.

22. The apparatus of claim 21, wherein the processor to configure the programmable digital filter to match the filter characteristic to the measured RF filter characteristic is further configured to set the digital amplitude versus frequency function to the RF amplitude versus frequency function to within an amplitude tolerance, and to set the digital phase versus frequency function to the RF phase versus frequency function to within a phase tolerance.

23. The apparatus of claim 16, wherein the processor is further configured to inject a test signal into an input of the enabled RF receive filter for measuring the RF filter characteristic and to inject the test signal into a reference path to obtain the filter characteristic;
and wherein the programmable digital filter is part of the reference path.

24. The apparatus of claim 16, wherein the programmable digital filter is part of a reference path and the programmable digital filter comprises an attenuator to provide attenuation to complement a coarse attenuation in the reference path.

25. The apparatus of claim 16, wherein the programmable digital filter comprises a plurality of delays and a plurality of gains to implement matching the filter characteristic to the measured RF filter characteristic.

26. The apparatus of claim 16, wherein the programmable digital filter matches the filter characteristic to the measured RF filter characteristic by performing one of the following: an Impulse Invariance Transformation, a Bilinear Transformation, a polynomial curve fitting or a sinc interpolation.

27. The apparatus of claim 16, wherein the summer is further configured to subtract the reference signal from a receive signal in the receive path.

28. An apparatus for cancelling interference, comprising:
means for storing a plurality of victim bands, the means for storing coupled to at least one processor;
means for enabling a radio frequency (RF) receive filter for one of the plurality of victim bands from a plurality of RF receive filters in a receive path, wherein each of the plurality of RF receive filters is for a unique band and wherein said enabling is done prior to downconverting an RF signal in the receive path;
means for measuring an RF filter characteristic of the enabled RF receive filter;
means for configuring a programmable digital filter to match a filter characteristic to the measured RF filter characteristic to yield a reference signal; and
means for providing the reference signal through a summer to the receive path for interference cancellation.

29. The apparatus of claim 28, further comprising means for injecting a first test signal into an input of the enabled RF receive filter for measuring the RF filter characteristic and means for injecting a second test signal into a reference path to obtain the filter characteristic, wherein the programmable digital filter is part of the reference path.

30. A non-transitory computer-readable storage medium storing computer executable code, operable on a device comprising at least one processor; a memory for storing a plurality of victim bands, the memory coupled to the at least one processor; and the computer executable code comprising:
instructions for causing the at least one processor to enable a radio frequency (RF) receive filter for one of the plurality of victim bands from a plurality of RF receive filters in a receive path, wherein each of the plurality of RF receive filters is for a unique band and wherein said enabling is done prior to downconverting an RF signal in the receive path;
instructions for causing the at least one processor to measure an RF filter characteristic of the enabled RF receive filter;
instructions for causing the at least one processor to configure a programmable digital filter to match a filter characteristic to the measured RF filter characteristic to yield a reference signal; and
instructions for causing the at least one processor to provide the reference signal through a summer to the receive path for interference cancellation.
